(19) United States
(12) Patent Application Publication
(10) Pub. No.: US 2012/0070482 A1
(43) Pub. Date: Mar. 22, 2012

(54) FORMULATION COMPRISING AVERMECTIN PARTICLES COATED WITH A PHOTO-PROTECTING AGENT

(75) Inventors: Alexander Mark Heming, Muenchwilen (CH); Andrew James Pierce, Berkshire (GB); Johanna Martina Williams, Muenchwilen (CH)

(73) Assignee: SYNGENTA CROP PROTECTION, LLC, Greensboro, NC (US)

(21) Appl. No.: 13/257,158

(22) PCT Filed: Mar. 12, 2010
(86) PCT No.: PCT/GB2010/000464

§ 371 Date: Nov. 28, 2011

(30) Foreign Application Priority Data
Mar. 18, 2009 (GB) 0904659.0

(51) Int. Cl. A01N 25/26; A01N 43/22; A01N 25/12; A01N 25/02; A01N 25/14

(52) U.S. Cl. 424/405; 514/30; 514/53

(57) ABSTRACT

A composition comprising a pesticide (A) selected from avermectin and a photo-protecting agent, wherein the mean diameter of the pesticide (A) particles is from 0.1 to 100 μm and where the amount of photo-protecting agent in the composition does not exceed 20% of the total weight of the pesticide (A) particles plus the agent, and its use in agriculture. The avermectin particles are preferably coated with the photo-protecting agent.

The present invention relates to defined pesticide compositions containing a low amount of photo-protecting agent, in particular compositions comprising the pesticide particles coated with a photo-protectant agent, to formulations comprising such compositions, to the use of such compositions and formulations and to a process for preparing such compositions and formulations.

Pesticides are typically applied to agricultural crops where they are biologically active in controlling pests on or within the leaves of the plants. Many pesticide compounds are degraded by sunlight (photolysed) or by chemical reactions with energetic species created by the action of sunlight, for example singlet oxygen, while on the leaf surface or within the leaf. Sometimes the rate of photo-degradation is so fast that the required biological control of the pests is lost prematurely. Loss of pesticide compound by photo-degradation must be compensated for in the quantity of pesticide compound initially applied to the crop. The result is that more pesticide compound than is actually required for effective biological control of the pests is applied, which has commercial and environmental implications. Thus, there exists a need for pesticide compositions whereby the rate of photo-degradation of the pesticide is reduced.

It is common practice to include an anti-oxidant in an agrochemical product to increase its shelf life. This is separate and distinct from the deliberate addition of a photo-protecting compound in order to reduce the rate of photo-degradation when the product is applied to crops in the field.

Some examples of the use of photo-protecting compounds to reduce the rate of photo-degradation of a pesticide and thereby improve its efficacy exist in the art.

Granular pesticide compositions comprising lignin or modified lignins are described in chapter 8 of Controlled-Release Delivery Systems for Pesticides (ed. Scher, H., Marcel Dekker, New York, 1999). These compositions are prepared by co-melting the pesticide with a lignin and cooling the resultant melt to form a glass, which is then further processed to form granules.

WO03005816 describes micro-particles comprising pesticide particles in a lignin matrix prepared by forming a water-in-oil emulsion of the pesticide and a lignin co-dissolved in an organic solvent and then removing the solvent to give solid micro-particles. The disclosed compositions comprise lignin at more than seven times the weight of pesticide compound. This high photo-protector to pesticide ratio is necessary in order to form spherical micro-particles that fully entrap all the pesticide particles.

U.S. Pat. No. 5,965,123 describes pesticide compositions wherein the pesticide compound is present as particles entrapped in a matrix comprising a “pH-dependent polymer”, a plasticiser and an ultraviolet protector.

WO0213608 describes oil based dispersions of pesticide compounds coated with a lignin. Pesticide particles are co-formulated with the lignin by means of common methods such as suspending the pesticide particles in aqueous lignin solution and then spray drying to give a solid material which comprises a plurality of pesticide particles entrapped in a lignin matrix.

Demchak and Dybas demonstrated that abamectin, an insecticide used principally in agriculture, can be entrapped in a matrix of zein, a plant derived protein, to form a composition with increased photostability (Journal of Agricultural and Food Chemistry; 45, 1, 1997, 260-262, pub. American Chemical Society).

In all these cases the photo-protecting compound is formulated in a solid matrix, wherein each granule or micro-particle of the composition contains a plurality of pesticide particles. Even for those approaches where the solid composition is further processed the pesticide particles are not discrete, with an individual coating of photo-protecting compound, but exist as clusters bound together by a matrix. The disadvantage of these approaches is that the amount of photo-protecting compound required relative to the amount of pesticide is very high. The weight ratio of photo-protecting compound to pesticide exceeds 1:1 in every case. It is not cost or volume efficient to use large amounts of photo-protecting compound relative to pesticide.

WO0226040 describes a process for coating particles suspended in water by using the natural electrostatic charge on the particle surfaces to attract and bind oppositely charged polymers. Photo-protecting particles were bound to the surface of the particles during this process. It will be apparent to one skilled in the art that such coacervation methods are difficult to carry out because the outcome is highly dependent on the nature of the particles and the polymers. It is common when carrying out coacervation processes to prepare clusters of particles bound together with the polymer, rather than discrete particles, and controlling the cluster size is difficult. It is also a disadvantage of this method that the size and nature of the photo-protecting particles must be very carefully selected in order that they pack around the pesticide particles and give effective photo-protection.

WO06077394 describes the use of polymeric microcapsules wherein a photo-protecting dye is co-dissolved with a pesticide or other biologically active compound, US2007275853 describes polymeric microcapsules with a photo-protecting stabiliser bound into the microcapsule wall or co-dissolved with a biologically active compound within the microcapsule and U.S. Pat. No. 5,455,048 describes microcapsules comprising an oily liquid core wherein “sunscreen” inorganic particles are dispersed.

It is a disadvantage of microencapsulation that it is not a suitable process for many pesticide compounds since they must be soluble in a suitable solvent and chemically inert with respect to the encapsulation process used. There are also cost implications associated with microencapsulation, for example, the increased cost of processing and the relatively low total loading of pesticide compound that can be incorporated into the product.

EP1306008 describes conventional water dispersible granules comprising a plant based material as filler and, optionally, a particulate photo-protecting material such as carbon black or clay. Although no data are presented, one skilled in the art will appreciate that a relatively small amount of a particulate photo-protecting material relative to pesticide will not be effective to photo-protect the pesticide in the dry spray deposit on a leaf surface because the discrete photo-protector and pesticide particles are not closely associated and are likely to sit side by side instead, leaving the pesticide particles exposed to sunlight.

WO07053760 describes compositions of pesticides that are degraded by singlet oxygen, a common photo-chemical degradation mechanism, that are co-formulated with an activity-enhancer that protects or stabilises the pesticide from reaction with singlet oxygen, in other words, an anti-oxidant. In the examples given the pesticide and anti-oxidant compounds are simply co-formulated or mixed together immediately prior to spraying (tank mixed). The weight ratio used is between 2 and 80 parts anti-oxidant to 1 part pesticide.

Thus, there exists a need for a pesticide composition comprising a pesticide that is photo-protected by low amounts of photo-protecting compound relative to pesticide, in particular where the photo-protecting compound and pesticide are closely associated with one another in order to be most effective and which may be prepared by a process that is effective for a wide range of pesticides.

The present invention relates to compositions comprising a defined pesticide having particles of mean diameter from 0.1 to 100 μm and a photo-protecting agent, where the total weight of the agent in the composition does not exceed 20% of the total weight of the particles plus the agent. These compositions have surprisingly been found to address the disadvantages of the prior art.

Accordingly, the present invention provides in a first aspect a composition comprising a pesticide (A) which is an avermectin and a photo-protecting agent, wherein the mean diameter of the pesticide (A) particles is from 0.1 to 100 μm and where the amount of photo-protecting agent in the composition does not exceed 20% of the total weight of the pesticide (A) particles plus the agent.

In an embodiment, a composition of the first aspect is obtainable by coating each pesticide (A) particle with the photo-protecting agent, such that the photo-protecting agent and pesticide are closely associated with one another.

In a preferred embodiment, each pesticide (A) particle is coated with the photo-protecting agent. In such an instance, the mean diameter of the particles is that of the coated particles; and similarly the total weight of the pesticide (A) particles plus the agent is that of the total weight of the coated pesticide (A) particles.

The particles present in the composition, whether coated or uncoated, are single solid particles or mononucleate solid particles.

Compositions comprising pesticide particles coated as discrete particles are known in the art. US2007275853 describes particles coated with a powder coating selected from various carbohydrate or cellulosic materials and WO9707676 describes crop protection solid particles, specifically herbicides, coated with various water insoluble materials to prevent degradation of the coated crop protection solid particles by other crop protection chemicals.

Pesticides suitable for use with the present invention are averrmectin and pyrethroid insecticides.

The invention is most useful for pesticides that are subject to degradation when exposed to sunlight, in particular an avermectin or a chemical derivative of avermectin (such as abamectin, ivermectin, selamectin, eprinomectin, doramectin and emamectin benzoate) and pyrethroid insecticides (such as deltamethrin, tralomethrin, cyfluthrin, alphamethrin, zeta-cypermethrin, fenvalerate, esfenvalerate, acrinathrin, allethrin, bifenthrin, bioallethrin, bioresmethrin, cycloprothrin, beta-cyfluthrin, cyhalothrin, beta-cypermethrin, cyphenothrin, empenthrin, etofenprox, fenpropathrin, flucythrinate, tau-fluvalinate, phenothrin, prallethrin, resmethrin, tefluthrin, tetramethrin or lambda-cyhalothrin; suitably lambda-cyhalothrin).

In the event the photo-protecting agent is coated on the pesticides, the physical properties such as melting or softening point of the pesticide must be suitable for the coating process selected. For example, when the coating process is based on that described in WO04054718 then the pesticide must be a solid with a softening point no lower than the melting point of the liquid coating material. Suitably the pesticide is one with a melting point greater than 80° C.

In an embodiment, the pesticide (A) of the composition according to invention is an avermectin, such as abamectin or emamectin benzoate. Preferably the pesticide (A) is emamectin benzoate.

In an embodiment, the pesticide (A) of the composition according to invention is a pyrethroid, such as such as deltamethrin, tralomethrin, cyfluthrin, alphamethrin, zeta-cypermethrin, fenvalerate, esfenvalerate, acrinathrin, allethrin, bifenthrin, bioallethrin, bioresmethrin, cycloprothrin, beta-cyfluthrin, cyhalothrin, beta-cypermethrin, cyphenothrin, empenthrin, etofenprox, fenpropathrin, flucythrinate, tau-fluvalinate, phenothrin, prallethrin, resmethrin, tefluthrin, tetramethrin or lambda-cyhalothrin; suitably lambda-cyhalothrin). Preferably the pesticide (A) is lambda-cyhalothrin.

In an embodiment, pesticide (A) can be a mixture of avermectins or mixture of pyrethroids or a mixture thereof, such as a mixture of abamectin and emamectin benzoate, and mixture of abamectin and lambda-cyhalothrin.

In an embodiment, the amount of pesticide (A) in a composition of the present invention is from 0.1 to 98, preferably 0.5 to 99, especially 1 to 95, %, based on the weight of the composition.

In the event the pesticide (A) particles are coated with the photo-protecting agent, the pesticide particles are at least partially coated with a photo-protecting agent (or coating) such that discrete pesticide particles are individually coated without gross agglomeration or entrapment of the particles within a matrix of the coating material. The particles can be referred to as single solid particles or mononucleate solid particles. In this case, the term “partially coated” means that the particles are, on average, nearly completely coated, but that the coating may not be completely contiguous around the entire surface of every particle (i.e. there may still be portions of the surfaces of some particles that have not been coated). Therefore, the term “at least partially coated” covers the situations where (i) all particles are fully coated; (ii) some particles are fully coated whilst others are partially [almost fully] coated; and (iii) all the particles are partially [almost fully] coated. The coating on the pesticide particles of the present invention has a photo-protecting action; the extent to which the particles must be coated is such that the coating provides the pesticide particles with an effective level of protection against photo-degradation.

A photo-protecting agent is one or more compounds that reduces the rate of degradation of the pesticide by reactions caused by or catalysed by the action of sunlight. One skilled in the art will appreciate that a variety of such compounds are available and that they have different operating mechanisms. For example, one or more of wood rosin, rosin derivatives, waxes, fatty derivatives, sterols, long-chain sterol esters, competitive photon absorbers and antioxidants can be suitable as a photo-protecting agent in the present invention.

Examples of rosin derivatives may be any of the following: partially dimerized rosin, partially hydrogenated rosin, salts of divalent metals, salts of tri-valent metals, adducts of maleic acid/anhydride, adducts of fumaric acid/anhydride or adducts of pentaerythritol, or mixtures of any of the foregoing. The salts of the divalent or tri-valent metals are derived from any of the following: calcium, magnesium, iron, zinc, aluminum, manganese and barium, or mixtures of any of these.

Examples of waxes may be of natural origin, meaning they may be animal, vegetable or mineral. Animal waxes include beeswax, lanolin, shellac wax and Chinese insect wax. Vegetable wax includes carnauba, candelilla, bayberry, and sugar cane waxes. Mineral wax includes fossil or earth waxes, including ozocerite, ceresin and montan, or petroleum waxes, including paraffin and microcrystalline waxes. Alternatively, the waxes may be synthetic, or mixtures of natural and synthetic waxes. For instance, in the event of the photo-protecting agent is coated, particular coating materials may include a low-molecular weight partially oxidized polyethylene, which is preferably co-melted with paraffin, low-molecular weight poly(ethylene/acrylic acid) or low-molecular weight poly(ethylene/methacrylic acid). It should be noted that the coating material may be any one of the waxes described in this paragraph, or a mixture of any of them.

Examples of fatty derivatives may be either fatty acids, fatty metallic salts of these fatty acids, fatty acid amides, fatty alcohols and fatty esters, or mixtures of any of the foregoing. In this context, “fatty” means long-chain aliphatic. In particular, the acid may be a carboxylic acid, such as stearic acid, and the salts may be calcium, magnesium, zinc or aluminum salts. The acid amide may be stearamide. The alcohol may be stearyl alcohol. The ester is formed from reaction of a long-chain acid with a long-chain alcohol. The ester may be a fatty acid ester of a fatty alcohol or a fatty acid ester of glycerol.

Sterols as such, or long-chain sterol esters, meaning an ester formed from a sterol, may also be used as the photo-protecting agent, particularly as a coating material. In either case, the sterols may be of animal origin (e.g., cholesterol) or of plant origin (e.g., ergosterol).

Examples of suitable competitive photon absorbers include hydroxybenzophenones, hydroxyphenylbenzotriazoles, hydroxyphenyltriazines, diphenylacrylates, cinnamic acid derivatives, carotenoids, flavonoids, mono- and bis-azo dyes, acridine dyes, anthroquinone dyes, indene dyes, indole dyes, indulin dyes, oxazone dyes, triarylmethane dyes and xanthene dyes.

Examples of antioxidants, or free-radical scavengers, include hindered amine light stabilisers (HALS), non-interacting hindered amine light stabilisers (NOR-HALS), thioester antioxidants, phosphite antioxidants, sulfite antioxidants, hindered phenols, polyphenols, tocopherols, aromatic amines, aminophenols, carotenoids, stable nitroxides and ascorbic acid.

In the instance the photo-protecting agent is used as a coating, the coating material has a melting point within the range of 55-220° C. When one is within 20° C. of the melting point, the molten coating material does not decompose and is filmforming, but not filament-forming.

Preferred photo-protecting agents are 2,6-di(tert-butyl)-4-methylphenol (commonly known as BHT); ethylenebis(oxyethylene)bis-(3-(5-tert-butyl-4-hydroxy-m-tolyl)-propionate) (available, for example, as Irganox™ 245); an azo dye (available, for example, as Oil Red O™ from Sigma-Aldrich); a synthetic beeswax (available, for example, as Syncrowax™ BB4 from Croda); and a UV absorber of the hydroxyphenylbenzotriazole class (available, for example, as Tinuvin™ 328 from BASF).

The type of photo-protecting agent used in the coating should act to reduce the rate of degradation of the pesticide due to the action of sunlight.

In the event of the photo-protecting agent is coated on the pesticides, without being bound by any particular theory, it is currently believed that the coating of photo-protecting agent used in the present invention is especially effective because the photo-protecting agent is closely associated with the pesticide compound at the surface of each particle, where the photo-degradation is most likely to occur and therefore where it is most needed.

The amount of photo-protecting agent in the composition, preferably coated on the pesticide particles, of the present invention is preferably from 0.1 to 20%, more suitably from 0.5 to 18%, advantageously from 1 to 15%, most suitably from 2 to 10%, by weight of total weight the particles and agent. The amount of photo-protecting material needed in any particular composition, to be effective, will depend on many variables, such as the photo-sensitivity of the pesticide, the choice of photo-protecting compound used and the size of the pesticide particles. The skilled user will be able to select a suitable coating material for each combination of desired pesticide and particle size.

The mean diameter of the pesticide particles, preferably coated pesticide particles, of the present invention is from 0.1 to 100 μm, preferably from 0.5 to 50 μm, more preferably from 1 to 10 μm, especially 2 to 6 μm. Accordingly, the preferred particle size at D[0.9]'s (the size below which 90% of the number of particles fall—see method ISO 13320-1:1999 for further details) is 4-10 μm. Methods to prepare pesticide particles of the preferred size range prior to coating will be known to those skilled in the art, for example air-jet milling, micronisation, dry grinding, hammer milling, pin milling, bead milling or ultra-sonic comminution. It is not an intention of the present invention to be limited by the process used to prepare the pesticide particles prior to coating them. In this case, mean diameter is taken to mean the number average mean diameter, as measured by a suitable particle sizing technique such as dynamic light scattering. One skilled in the art will be familiar with the differences in the various statistical definitions of mean particle size and how to measure them.

Methods to prepare compositions according to the invention involve suitable mixing of the pesticide having a defined particle size and the photo-protecting agent in defined amounts. Such methods are known to a skilled person.

The coating process of the present invention is suitably one where photo-protecting agent can be delivered to the surface of pesticide particles in a controlled manner without agglomeration of said particles. More suitably the coating process of the present invention is a technique where the pesticide particles are introduced into the process as a dry powder, are then coated with a liquid photo-protecting agent coating material that becomes a solid coating on the particles during the process and where the coated particles exit the process in a dry, non-agglomerated state. Such coating processes must consist of a means of maintaining good mixing and movement of the particles, for example in a gas flow or fluidised bed, and a method of introducing the liquid coating material as either a hot melt, a solution in a volatile solvent or a liquid that reacts to become a solid in such a way as to distribute the liquid evenly over the particle surfaces. This is usually accomplished by spraying the liquid into a mass of particles in a gas stream or fluidised bed. Examples of this type of process are the one disclosed in WO9707676 or Wurster coating techniques.

The method used to prepare pesticide particles of the present invention of the preferred size range and then to coat them is most suitably that described in WO04054718. In this process the starting material for the solid particles is introduced to a centrifugal milling chamber via a high pressure gas jet and at the same time the molten liquid for the coating material is introduced into the same chamber by a separate spray nozzle. The ratio of liquid to solid is controlled by a regulating unit. The solid particles are thus reduced in size by to comminution and coated with the liquid coating material in the same operation. The coated particles leave the mill once they are in a certain size range and are collected in a separating device.

The photo-protecting agent coating material for use in the most suitable embodiment of the present invention must therefore have the requisite properties for use in the process. That is, it must be able to be dissolved or melted, pumped and atomised during the process and must then solidify to give a coating on the particles that is not soft or tacky at room temperature and is resilient during the expected storage life of the final product. The coating material may also suitably consist of a combination of two or more photo-protecting compounds or of a combination of one or more photo-protecting compounds and inert compounds that may be added to increase the efficacy of the coating process. The coating material for use in the present invention suitably has a melting point which is from 50 to 150° C., more suitably from 60 to 120° C. and most suitably from 70 to 100° C.; particularly suitable coating materials are 2,6-di(tert-butyl)-4-methylphenol (commonly known as BHT), having a melting point of 70-73° C.; and ethylenebis(oxyethylene)bis-(3-(5-tert-butyl-4-hydroxy-m-tolyl)-propionate) (available, for example, as Irganox™ 245), having a melting point 76-79° C.

The composition of the invention can be formulated for a particular use. Preferably, the composition is formulated for protecting cultivated plants or their propagation materials. Accordingly, a composition of the invention can be applied to the plant in a conventional manner, such as foliar spray. Also, a composition can be formulated for seed treatment applications for controlling or preventing damage by pests and/or pathogens, which are found in agriculture and forestry, and can particularly damage the plant in the early stages of its development. Also envisaged are methods of applying to the soil, which can be via any suitable method, which ensures that the pesticide penetrates the soil, for example, nursery tray application, in furrow application, soil drenching, soil injection, drip irrigation, application through sprinklers or central pivot, incorporation into soil (broad cast or in band) are such methods.

The compositions of the invention can be used in agriculture to improve plant growth. Examples of target crop plants include especially field crops fruits, vegetables, nuts, berries, tropical plantations, ornamentals and others, such as wheat, barley, rye, oats, rice, maize, sorghum, beans, lentils, peas, soybeans, rape, mustard, poppy, sugar- and fodder-beet, cotton, flax, hemp, jute, sunflowers, castor oil, groundnuts, potatoes, sweet potatoes, tobacco, sugar cane, apples, pears, plums, peaches, nectarines, apricots, cherries, oranges, lemons, grapefruit, mandarins, olives vines, hops, almonds, walnuts, hazelnuts, avocado, bananas, tea, coffee, coconut, cocoa, natural rubber plants, oil plants, grapes, strawberries, raspberries, blackberries, spinach, lettuce, asparagus, cabbages, chinese kale, carrots, onions, tomatoes, cucumbers, pepper, eggplants, melons, paprika, chilli, roses, chrysanthemums, cotton and carnations. The plants can also be genetically modified.

The rate and frequency of use of the composition on the plant may vary within wide limits and depends on the specific pesticide, type of use, the nature of the soil, the method of application (pre- or post-emergence, etc.), the plant or pest to be controlled, the prevailing climatic conditions, and other factors governed by the method of application, the time of application and the target plant. A skilled person would be able to choose the appropriate parameters for the application.

The compositions comprising the pesticides of the present invention will usually be further processed to prepare formulations such as those typically used in the agricultural industry, for example water dispersible concentrates such as suspension concentrates (SC), water dispersible granules (WG), wettable powders (WP) or oil flowable dispersions (OD). One skilled in the art will be able to select the appropriate type of formulation for the intended product together with the required co-formulants and processing conditions to prepare it. The compositions prepared from the coated pesticide particles of the present invention may suitably contain further photo-protecting agents in addition to the coating on the particles. For example, sodium lignosulfonates employed as dispersing agents in granule compositions may provide further photo-protection to the pesticide particles in addition to the particle coating.

In a preferred embodiment, a composition of the invention in the form of a pepite water dispersible granules (WG), wherein a co-formulant in the formulation is a sodium lignosulfonates (commercially known, for example, as Polyfon H).

In an embodiment, the amount of pesticide (A) in a formulation of the present invention is from 0.1 to 50, preferably 0.5 to 20, especially 0.95 to 10, % based on the weight of the formulation.

The composition of the present invention may also be prepared as a concentrated product for use in preparing a formulation typically used in the agricultural industry. In such a case, the amount of pesticide (A) in the composition would be more, such as 50 to 99, preferably 75 to 98, especially 85 to 95, % based on the weight of the composition.

Whereas commercial products will preferably be formulated as concentrates (e.g., pre-mix composition (formulation)), the end user will normally employ dilute formulations (e.g., tank mix composition).

The tank-mix compositions are generally prepared by diluting with a solvent (for example, water) the one or more pre-mix compositions containing different pesticides, and optionally further auxiliaries. In this context, one of said pre-mix is the composition according to the present invention. The second pre-mix can be another composition containing a different pesticide.

Further, the compositions of the present invention, including the formulations, comprise a pesticide (B) other than an avermectin or a pyrethroid.

Examples of pesticide (B) include fungicides and other insecticides, including lufenuron, thiamethoxam, fipronil, imidacloprid and chlorantraniliprole.

In an embodiment, mean diameter of pesticide (B) particles', independently of pesticide (A), corresponds to the mean diameter of pesticide (A) particles' mentioned above.

In an embodiment, each pesticide (B) particle, independently of the coating in pesticide (A) or amount of coating on pesticide (A), is coated with a photo-protecting coating, as defined herein, in an amount that does not exceed 20% of the total weight of the pesticide (B) particles plus the coating (i.e. weight of the coated pesticide (B) particles). Preferably the amount of photo-protecting coating is from 0.01 to 20, such as 0.5 to 18, more preferably from 1 to 15, most preferably from 2 to 10, %, by weight of the coated pesticide (B) particles.

Therefore, the weight ratio of photo-protecting agent to pesticide (whether (A) alone or both (A) and (B)) in the composition according to the invention would never exceed 20:100, preferably the weight ratio is 0.01 to 20:100, more preferably 0.5 to 18:100; especially 1 to 15:100, advantageously 2 to 10:100.

In an embodiment, in the event pesticide (B) is coated, the photo-protecting coating for pesticide (A) and pesticide (B) is same or different.

In the event there are more than one pesticide (A) and/or more than one pesticide (B) in the composition, the photo-protecting coating can be the same or different for each pesticide (A) and each pesticide (B).

The compositions of the present invention find particular use in agriculture and related industry. The compositions are suitable for controlling the damage caused by pests, such as insects, fungi, weeds, on a plant, and for improving the growth of a plant.

Examples of insects include the order Lepidoptera are for example, Acleris spp., Adoxophyes spp., Aegeria spp., Agrotis spp., Alabama argillaceae, Amylois spp., Anticarsia gemmatalis, Archips spp., Argyrotaenia spp., Astylus atromaculatus, Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Heteronychus arator, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; the insects of the order Coleoptera are for example, Agriotes spp., Anthonomus spp., Atomaria linearis, Chaetocnema tibialis, Conotrachelus spp., Cosmopolites spp., Curculio spp., Dermestes spp., Diabrotica spp., Dilopoderus spp., Epilachna spp., Eremnus spp., Heteronychus spp., Leptinotarsa decemlineata, Lissorhoptrus spp., Melolontha spp., Melolontha melolontha, Orycaephilus spp., Otiorhynchus spp., Phlyctinus spp., Popillia spp., Popillia japonica, Psylliodes spp., Rhizopertha spp., Scarabeidae, Somaticus spp., Sitophilus spp., Sitotroga spp., Tanymecus spp., Tenebrio spp., Tribolium spp., Trogoderma spp., Phyllotreta spp., Ceutorhynchus spp., Cyclocephala hirta, Cyclocephala pasadenae, Macrodactylus subspinosus, Macrodactylus uniformis and Zabrus spp.; the insects of the order Orthoptera are for example, Blatta spp., Blattella spp., Gryllotalpa spp., Leucophaea maderae, Locusta spp., Periplaneta spp. And Schistocerca spp.; the insects of the order Psocoptera are for example Liposcelis spp.; the insects of the order Anoplura are for example, Haematopinus spp., Linognathus spp., Pediculus spp., Pemphigus spp. And Phylloxera spp.; the insects of the order Isoptera are for example, Reticulitermes spp. Such as R. flavipes, R. 13hallus13, R. tibialis, R. virginicus, R. santonensis, R. hageni, Coptotermes spp., such as C. formosanus, Nasutitermes ssp. And Macrotermes spp.; the insects of the order Mallophaga are for example, Damalinea spp. And Trichodectes spp.; the insects of the order Thysanoptera are for example, Frankliniella spp., Hercinothrips spp., Taeniothrips spp., Thrips palmi, Thrips tabaci and Scirtothrips aurantii; the insects of the order Heteroptera are for example, Cimex spp., Distantiella theobroma, Dysdercus spp., Euchistus spp. Eurygaster spp. Leptocorisa spp., Nezara spp., Piesma spp., Rhodnius spp., Sahlbergella singularis, Scotinophara spp. And Triatoma spp.; the insects of the order Homoptera are for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysom13hallus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; the insects of the order Hymenoptera are for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. And Vespa spp.; the insects of the order Diptera are for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp., Delia spp., Anopheles spp. And Tipula spp.; the insects of the order Siphonaptera are for example, Ceratophyllus spp. And Xenopsylla cheopis; the insects of the order Thysanura are for example, Lepisma saccharina; and amongst the representatives of the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. And Tetranychus spp.

In the instance of one or more pesticide (B) is used in combination with pesticide (A), the composition of the present invention would be suitable for control of a wider spectrum of pests, such as fungi, weeds or nematodes.

The Pesticide Manual 14th edition published by the British Crop Protection Council in 2006 provides details of pesticides.

The following Examples illustrate the present invention and refer to the following materials: Atlox™ 4913 is an acrylic graft copolymer dispersant available from Croda; Celite™ 209 is a diatomaceous earth available from Celite Corp.; Dispergator™ B is the sodium salt of sulfonated dibutylnaphthalene purchased from Ledertechnik GmbH; 2,6-di(tert-butyl)-4-methylphenol (BHT) was purchased from Sigma-Aldrich; emamectin benzoate technical grade is an insecticide from Syngenta; Geropon™ T77 is sodium N-methyl-N-oleyl taurate and Geropon™ TA72 is polycarboxylate dispersant both available from Rhodia; Irganox™ 245 is an anti-oxidant available from Ciba Specialties; the lactose used was anhydrous tableting grade purchased from Fonterra Excipients GmbH; Morwet™ D425 is the sodium salt of sulfonated naphthalene-formaldehyde condensate available from Akzo Nobel; Oil Red O™ is an azo dye and was purchased from Sigma-Aldrich; Pergopak™ M is a urea-formaldehyde polymer granule available from Albermarle Corp.; Polyfon™ H is a high molecular weight sodium lignosulfonate available from Meadwestvaco; Proxel™ GXL is a water dispersible solution of 1,2-benzisothiazol-3(2H)-one available from Arch Biocides; Rhodopol™ 23 is a polysaccharide biopolymer available from Rhodia; Rhodorsil™ EP6703 is a silicon antifoam powder available from Rhodia; SAG™ 1572 is a silicon oil emulsion available from GE Specialty Materials; Sellogen™ DFL is a sodium alkyl naphthalene sulfonate available from Cognis; Syncrowax™ BB4 is a synthetic beeswax available from Croda.; Tinuvin™ 328 is a UV absorber of the hydroxyphenylbenzotriazole class available from BASF; Ufoxane™ 3A and Ultrazine™ NA are sodium lignosulfonates available from Borregaard Industries; and urea, technical grade, was purchased from Atochem.

### EXAMPLE 1

This Example describes a process for coating pesticide particles with a photo-protecting compound using a modified air-jet mill as described in WO04054718. The process was operated under nitrogen gas with an injector pressure of 6.0 bar and a milling chamber pressure of 5.0 bar. Technical emamectin benzoate was fed into the mill at a throughput of 5.0 kg per hour using a twin-screw powder feeder. The liquid injection nozzle and pump were heated to the requisite temperatures to maintain the coating material as a sprayable liquid (temperatures given as Pump T. and Nozzle T. in Table 1). The liquid injection rate was varied to control the coating thickness and the liquid injection pressure was maintained at between 4.5-5.0 bar. The resulting samples of coated particles had number average particle sizes of 1.5-3.0 μm and D[0.9]'s (the size below which 90% of the number of particles fall) of 4-7 μm as measured in aqueous dispersion by laser light scattering (Malvern Mastersizer X).

TABLE 1

| | % w/w | Coating | Pump T. | Nozzle T. | Injection |
|---|---|---|---|---|---|
| Ex. | Coating ^{(a)} | composition | (° C.) | (° C.) | rate ^{(b)} |
| 1A | — | None | — | — | — |
| | | (comparative example) | | | |
| 1B | 5.0 | Irganox 245 | 100 | 110 | 260 |
| 1C | 2.5 | Irganox 245 | 100 | 110 | 125 |
| 1D | 2.0 | Irganox 245 | 100 | 110 | 100 |
| 1E | 0.2 | Irganox 245 | 100 | 110 | 10 |
| 1F | 2.0 | 2,6-di(tert-butyl)-4- | 90 | 100 | 100 |
| | | methylphenol (BHT) | | | |
| 1G | 10.0 | 1 part Irganox 245, | 90 | 130 | 560 |
| | | 9 parts Syncrowax BB4 | | | |
| 1H | 2.5 | 1 part Irganox 245, | 90 | 130 | 125 |
| | | 9 parts Syncrowax BB4 | | | |
| 1I | 2.5 | 3 parts Irganox 245, | 120 | 120 | 125 |
| | | 1 part Oil Red O | | | |
| 1J | 0.2 | 3 parts Irganox 245, | 120 | 120 | 10 |
| | | 1 part Oil Red O | | | |
| 1K | 10 | 1 part Oil Red O, | 120 | 120 | 560 |
| | | 9 parts Syncrowax BB4 | | | |
| 1L | 5.0 | Tinuvin 328 | 100 | 110 | 260 |
| 1M | 10 | Syncrowax BB4 | 120 | 120 | 560 |

^{(a)} Expressed as weight % of the total weight of the coated particles;
^{(b)} Injection rate gravimetrically controlled in units of g/hr.

### EXAMPLE 2

This Example describes a process for preparing suspension concentrate (SC) formulations from the coated particles of Example 1. The samples were prepared according to the following formula [Table 2a] and method:

TABLE 2a

| Component | Parts by weight | |
|---|---|---|
| Coated particles | 10 | parts |
| Atlox 4913 | 2 | parts |
| Morwet D425 | 1.25 | parts |
| SAG 1572 | 0.3 | parts |
| Propylene glycol | 1 | part |
| Rhodopol 23 | 0.4 | parts |
| Proxel GXL | 0.1 | parts |
| Tap water | 84.95 | parts |

Morwet D425 and Atlox 4913 were dissolved in the tap water, the SAG 1572 was added and a coated pesticide powder according to Table 1 was blended in with high energy mixing (Polytron rotor-stator mixer). The remaining components were added and mixed until well dispersed. Table 2b shows which coated pesticide powders of Table 1 were used in this Example:

TABLE 2b

| Example | Coated particles used |
|---|---|
| 2A | 1A |
| 2B | 1C |
| 2C | 1E |
| 2D | 1I |
| 2E | 1J |
| 2F | 1H |
| 2G | 1K |
| 2H | 1L |
| 2I | 1M |

### EXAMPLE 3

This Example describes a process for preparing soluble granule (SG) formulations from the coated particles of Example 1. The components were first thoroughly mixed using a powder-mixer (Eirich, lab scale) and then 9 parts by weight water were added and mixed to form a paste with a crumbly consistency. The paste was extruded using a dome extruder (Fuji) fitted with a 0.6 mm screen and the granules were then dried in a fluid bed drier (Aeromatic) using an inlet temperature of 60° C. Drying was continued until an outlet temperature of 40° C. was achieved. Tables 3a and 3b show the formulae used and which samples from Example 1 were involved:

TABLE 3a

| Example | 3A | | 3B | | 3C | | 3D | |
|---|---|---|---|---|---|---|---|---|
| Coated particles | 1A | | 1B | | 1B | | 1A | |
| from Example 1 | 5 | parts | 5.25 | parts | 5.25 | parts | 5 | parts |
| Geropon T77 | 7.5 | parts | 7.5 | parts | | | 7.5 | parts |
| Sellogen DFL | 1 | part | 1 | part | 1 | part | 1 | part |
| Polyfon H | | | | | 7.5 | parts | | |
| Rhodorsil | 0.1 | parts | 0.1 | parts | 0.1 | parts | 0.1 | parts |
| EP6703 | | | | | | | | |
| Irganox 245 | | | | | | | 5 | parts |
| Lactose | to | | to | | to | | to | |
| | 100 | parts | 100 | parts | 100 | parts | 100 | parts |

TABLE 3b

| Example | 3E | | 3F | | 3G | | 3H | | 3I | |
|---|---|---|---|---|---|---|---|---|---|---|
| Coated particles | 1A | | 1D | | 1D | | 1D | | 1G | |
| from Example 1 | 5 | parts | 5.1 | parts | 5.1 | parts | 5.1 | parts | 5.5 | parts |
| Sopropon TA72 | 2 | parts | 2 | parts | 2 | parts | 2 | parts | 2 | parts |
| Dispergator B | 5 | parts | 5 | parts | 5 | parts | 5 | parts | 5 | parts |
| Ufoxane 3A | 10 | parts | 10 | parts | | | 10 | parts | 10 | parts |
| Polyfon H | | | | | 10 | parts | | | | |
| Rhodorsil | 1 | part | 1 | part | 1 | part | 1 | part | 1 | part |
| EP6703 | | | | | | | | | | |
| Pergopak M | 10 | parts | 10 | parts | 10 | parts | 10 | parts | 10 | parts |
| Urea tech. | to | | to | | to | | to | | to | |
| | 100 | parts | 100 | parts | 100 | parts | 100 | parts | 100 | parts |

### EXAMPLE 4

This example describes a process for preparing water dispersible granule (WG) formulations from the coated particles of example 1 using a spray drying granulation technique. Ultrazine NA and Celite 209 were mixed in the ratios given in the following table into 25-30 parts of water by weight using a high-shear, rotor-stator mixer and then passed through a bead mill (Dynomill, 2 mm glass beads, 80% bead charge). Rhodorsil EP6703 was added followed by the coated particles, which were fully dispersed into the slurry using the high shear mixer. The slurry was sprayed into a spray drier (Glatt, WG4) through a 1.8 mm co-axial nozzle at a flow rate of 18 litres/hr (1.8 bar) using a drying air throughput of 250 m³/hr with an inlet temperature of 90° C. Drying was continued until an outlet temperature of 55° C. was achieved.

Table 4 shows the formulae used and which samples from Example 1 were involved:

TABLE 4

| Example | 4A | | 4B | |
|---|---|---|---|---|
| Coated particles | 1A | | 1D | |
| from Example 1 | 5 | parts | 5.1 | parts |
| Ultrazine NA | 30 | parts | 30 | parts |
| Rhodorsil | 1 | part | 1 | part |
| EP6703 | | | | |
| Celite 209 | to | | to | |
| | 100 | parts | 100 | parts |

### EXAMPLE 5

This example demonstrates the improved photo-stability of the pesticide compositions containing coated particles. The formulations prepared in Examples 2, 3 and 4 were diluted in de-ionised water to give 50 mg emamectin benzoate per litre. For each formulation tested, eight 2 μl droplets were applied to a clean glass microscope slide and were allowed to dry prior to being covered with a UV transparent silica slide and placed in a Suntest (Hanau) which exposed the droplets to a xenon lamp simulating sunlight. After exposure, the slide was rinsed with 10 ml acetonitrile/tetrahydrofuran/0.1% aqueous phosphoric acid (40/10/50 by weight) and the rinsing was subsequently analysed for emamectin benzoate content by high performance liquid chromatography coupled to a mass spectrometer. Between 5 and 8 slides were prepared for each formulation and were exposed for different times to give a photo-degradation loss curve which was used to calculate a half-life (T₅₀) for each formulation. The improvement in photo-stability of each formulation is expressed as the ratio of the half-life of that formulation to the half-life of a similar, nonphoto-stabilised comparative example. Proclaim™ 05SG is a product of Syngenta and is a soluble granule composition containing 50 g/kg of emamectin benzoate. Table 5 shows the formulations used and for each formulation the half-life divided by that of a Comparative Example:

TABLE 5

| Example | Photo-protecting coating | T₅₀/T_{50 (comp)} ^{(a)} |
|---|---|---|
| Proclaim | None | Comparison to 2B-F |
| 05SG | | |
| 2B | 2.5% Irganox 245 | 12.7 |
| 2C | 0.2% Irganox 245 | 8.9 |
| 2D | 2.5% 3 parts Irganox 245, | 22.5 |
| | 1 part Oil Red O | |
| 2E | 0.2% 3 parts Irganox 245, | 10.0 |
| | 1 part Oil Red O | |
| 2F | 2.5% 1 part Irganox 245, | 14.2 |
| | 9 parts Syncrowax BB4 | |
| 2A | None | Comparison to 2G |
| 2G | 10% 1 part Oil Red O, | 2.3 |
| | 9 parts Syncrowax BB4 | |
| 2H | 5% Tinuvin 328 | 2.5 |
| 2I | 10% Syncrowax BB4 | 1.4 |
| 3A | None | Comparison to 3B-D |
| 3B | 5% Irganox 245 | 3.6 |
| 3C | 5% Irganox 245 coating | 7.1 |
| | (7.5% Polyfon H in formulation) | |
| 3D | No coating, 5% Irganox 245 | 2.8 |
| | in formulation | |
| 3E | None | Comparison to 3F-I |
| 3F | 2% Irganox 245 | 1.1 |
| 3G | 2% Irganox 245 coating | 3.6 |
| | (10% Polyfon H in formulation) | |
| 3H | 2% BHT | 1.3 |
| 3I | 10% 1 part Irganox 245, | 2.8 |
| | 9 parts Syncrowax BB4 | |
| 4A | None | Comparison to 4B |
| | (30% Ultrazine NA in formulation) | |
| 4B | 2% Irganox 245 coating | 2.2 |
| | (30% Ultrazine NA in formulation) | |

(a) Ratio of half-life of sample with coated pesticide to half-life of comparative example.

1. A composition comprising a pesticide (A) which is an avermectin and a photo-protecting agent, wherein the mean diameter of the pesticide (A) particles is from 0.1 to 100 μm and where the amount of photo-protecting agent in the composition does not exceed 20% of the total weight of the pesticide (A) particles plus the agent.

2. A composition as claimed in claim 1 where the composition is obtainable by coating each pesticide (A) particle with the photo-protecting agent.

3. A composition as claimed in claim 1 wherein each pesticide (A) particle is coated with the photo-protecting agent.

4. A composition as claimed in claim 1 where the total weight of the agent is from 0.1 to 20% of the total weight of the pesticide (A) particles plus the agent.

5. A composition as claimed in claim 1 where the mean diameter of the pesticide (A) particles is from 0.5 to 50 μm.

6. A composition as claimed in claim 5 where the mean diameter of the pesticide (A) particles is from 1 to 10 μm.

7. A composition as claimed in claim 1 where the avermectin particles are abamectin and/or emamectin benzoate particles.

8. A composition as claimed in claim 7 where the avermectin particles are emamectin benzoate particles.

9. A composition as claimed in claim 1 where the composition further comprises one or more pesticide (B) other than avermectin.

10. A composition as claimed in claim 9 wherein the mean diameter of the particles of the pesticide (B) is from 0.1 to 100 μm.

11. A composition as claimed in claim 9 wherein the total weight of the photo-protecting agent in the composition does not exceed 20% of the total weight of the pesticides (A) and (B) particles plus the agent.

12. A composition as claimed in claim 11 where the composition is obtainable by coating each pesticide (A) and (B) particle with the photo-protecting agent.

13. A composition as claimed in claim 11 wherein each pesticide (A) and (B) particle is coated with the photo-protecting agent.

14. A composition as claimed in claim 1 where the photo-protecting agent material has a melting point which is from 50 to 150° C.

15. A composition as claimed in claim 14 where the photo-protecting agent material has a melting point which is from 60 to 120° C.

16. A composition as claimed in claim 15 where the photo-protecting agent material has a melting point which is from 70 to 100° C.

17. A composition as claimed in claim 16 where the agent comprises 2,6-di(tert-butyl)-4-methylphenol.

18. A composition as claimed in claim 16 where the agent comprises ethylenebis(oxyethylene)bis-(3-(5-tert-butyl-4-hydroxy-m-tolyl)-propionate).

19. A composition as claimed in claim 1 where the agent consists of one or more photo-protecting compounds.

20. A composition as claimed in claim 1 where the agent is a mixture of one or more photo-protecting compounds and one or more non-photo-protecting compounds.

21. A composition as claimed in claim 13 where the photo-protecting agent for pesticide (A) particle is same or different to the photo-protecting agent for pesticide (B) particle.

22. A formulation which is a suspension concentrate, water dispersible granule, wettable powder or oil flowable dispersion and which comprises a composition as defined in claim 1.

23. (canceled)

24. A process for preparing a composition as defined in claim 1 comprising a coating step in which a coating is delivered to the surfaces of pesticide particles in a controlled manner without agglomeration of said particles.

25. An avermectin particle coated with a photo-protecting agent, wherein the diameter of the particle is from 0.1 to 100 μm and where the amount of photo-protecting agent does not exceed 20% of the total weight of the coated particle.
